(19) United States
(12) Patent Application Publication
(10) Pub. No.: US 2007/0050585 A1
(43) Pub. Date: Mar. 1, 2007

(54) Selectively enabling playback of content on an optical medium

(75) Inventors: Tony New, Terre Haute, IN (US); Richard Selinfreund, Terre Haute, IN (US)

Correspondence Address: Trellis Intellectual Property Law Group, PC, 1900 EMBARCADERO ROAD, SUITE 109, PALO ALTO, CA, 94303, US

(73) Assignees: Sony DADC US INC., Terre Haute, IN (US); Veriloc LLC, Irvin, CA (US)

(21) Appl. No.: 11/508,563

(22) Filed: Aug. 22, 2006

Related U.S. Application Data
(60) Provisional application No. 60/711,178, filed on Aug. 24, 2005.

(51) Int. Cl. G06F 12/00

(52) U.S. Cl. 711/163

(57) ABSTRACT

A system for selectively inhibiting unauthorized use of an optical device. In an illustrative embodiment, the system implements an optical-device play-prevention system and copy-prevention system. The system includes a first set of data that is encoded via pit structures of the optical disc. A read system, such as a disc drive, which includes a read laser, is adapted to read the first set of data. A first material, which is positioned on or within the disc, changes transparency to laser light from the read laser in response to a first predetermined energy, such as ultrasound. A second material that is positioned on or within the disc temporarily changes transparency to the laser light, in response to a second predetermined energy, such as energy from the read laser. Changes in transparency of the first material and the second material change accessibility of the first set of data to the read system. The system further includes instructions executable by the read system for enabling or disabling reading, playing, and/or copying of the optical disc by the read system based on the accessibility of the first data to the read system.

### CLAIM OF PRIORITY

This invention claims priority from U.S. Provisional Patent Application Ser. No. 60/711,178, entitled ANTI-SHRINK-COPY PROTECTION PRODUCT, filed on Aug. 24, 2005, which is hereby incorporated by reference as if set forth in full in this application for all purposes.

### BACKGROUND OF THE INVENTION

This invention is related in general to feature-enabling systems and more specifically relates to systems and methods for selectively preventing unauthorized use of devices, such as optical and electronic devices and data-storage media.

Systems for preventing unauthorized use of certain device features are employed in various demanding applications including authentication, theft-prevention, and copy-prevention applications. Such systems are particularly applicable to data-storage media, where unauthorized playing and copying of data-storage media content is common.

Examples of data-storage media include, but are not limited to Compact Discs (CDs), Digital Video Discs (DVDs), Blu-ray discs, Electrically Erasable Programmable Read Only Memories (EEPROMs), Secure Digital (SD) cards, hard drives, Random Access Memories (RAMs), and Complimentary Metal Oxide Silicon (CMOS) memories. Such data-storage media are often employed in various devices, including smart cards, desktop computers, cameras, CD and DVD players, and so on.

Conventionally, to prevent unauthorized use of a device, such as playing of a stolen CD or DVD, special packaging is often employed. The packaging, which is often bulky, may contain a Radio Frequency Identification Tag (RFID) that is deactivated upon purchase. Deactivation of an RFID tag also deactivates alarm-triggering functionality, which would otherwise trigger an alarm when a customer exits a merchandise outlet, such as a store.

Unfortunately, thieves may readily notice and remove such tags. Furthermore, such packaging and associated RFID tags may increase product costs and may further emit undesirable radio frequencies even after deactivation.

Alternatively, the CD or DVD is coated with a special ink that gradually darkens when exposed to oxygen, eventually making the CD or DVD unplayable or copyable. Unfortunately, use of these inks or pigments limit legitimate uses of the devices. Consequently, use of these inks and pigments is often limited to device rental applications. Furthermore, such inks and pigments typically cannot prevent copying of the disc contents once the disc is purchased or rented.

### BRIEF DESCRIPTION OF THE DRAWINGS

FIG. 1 shows a system for selectively inhibiting unauthorized use of an optical disc according to a first embodiment of the present invention that employs two energy-sensitive materials.

FIG. 2 shows a cross-section of the optical disc of FIG. 1.

FIG. 3 shows an alternative embodiment of the system of FIG. 1, which employs energy-sensitive material at a predetermined location on the disc according to a second embodiment of the present invention.

FIG. 4 shows a cross-section of the optical disc of FIG. 3, wherein a an energy-sensitive material with transient optical properties is selectively disposed over pits of the optical disc, thereby affecting the way the pits are read by an accompanying reader.

FIG. 5 shows a cross-section of an optical disc with an accompanying energy-sensitive material disposed in a predetermined pattern over pits and lands of an optical disc according to a third embodiment of the present invention.

FIG. 6 shows a flow diagram of a first method adapted for use with the embodiments of FIGS. 1-4.

FIG. 7 shows a flow diagram of a second method adapted for use with the embodiments of FIGS. 1-4.

### SUMMARY OF EMBODIMENTS OF THE INVENTION

A preferred embodiment of the present invention implements a system for selectively inhibiting unauthorized use of an optical disc. In a specific implementation, the system prevents unauthorized playing and copying of the optical disc. The system includes a first set of data that is encoded via pit structures of the optical disc. A read system, which includes a read laser, is adapted to read the first set of data when the first set of data is exposed to the read system. A first material, which is positioned on or within the disc, permanently changes transparency to laser light from the read laser in response to a first predetermined energy, such as ultrasound. A second material that is positioned on or within the disc temporarily changes transparency to the laser light, in response to a second predetermined energy, such as energy from the read laser. Changes in transparency of the first material and the second material selectively change accessibility of the first set of data to the read system. The system further includes instructions executable by the read system for enabling or disabling reading, playing, and/or copying of the optical disc by the read system based on the accessibility of the first data to the read system.

The first material may be activated upon purchase of the disc, such as via a device that produces the first predetermined energy. Stolen optical discs may not be operable until activated via special equipment designed to produce the first predetermined energy. The second material may be sufficiently changed by a read laser to disable the optical disc or lock the read system, such as when a user attempts to copy the disc at a high rate. The second material may be configured so that changes in transparency of the first material do not cause disabling of the optical disc or locking of the read system, such as when the disc is played at low speeds. The first set of data may include instructions to disable the optical disc or the read system when the presence of the second material is lacking from an optical disc.

In an illustrative embodiment, the system implements a system for selectively enabling playing or copying of content from a data-storage medium. The system includes a first material disposed on or in the data-storage medium. A second optically transient material is disposed on or in the data-storage medium. A first mechanism employs the first material and the second material to selectively inhibit playing or copying of the content.

Hence, embodiments of the present invention may prevent both unauthorized playing and copying of content from an optical disc, such as a CD-ROM or DVD. This deters physical theft of the optical discs and deters content theft that might occur through copying and distributing the content. Use of the first and second materials, which may be implemented via Dye System 351 and Dye System 349, respectively, as discussed more fully below, may reduce costs associated with conventional security packaging.

### DETAILED DESCRIPTION OF EMBODIMENTS OF THE INVENTION

This invention is related to co-pending U.S. patent application Ser. No. 11/410,478, entitled SYSTEM AND METHOD FOR SELECTIVELY ENABLING OR DISABLING AN OPTICAL DEVICE, filed on Apr. 24, 2006, which is hereby incorporated by reference as if set forth in full in this application for all purposes,

For clarity, various well-known components, such as computers, power supplies, disc-manufacturing equipment, disc-drive motors, and so on, have been omitted from the figures. However, those skilled in the art with access to the present teachings will know which components to implement and how to implement them to meet the needs of a given application.

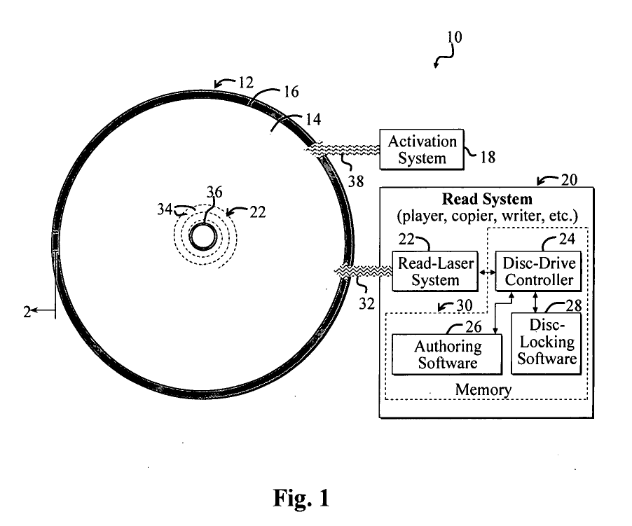

FIG. 1 shows a system 10 for selectively inhibiting unauthorized use of an optical disc 12 according to a first embodiment of the present invention that employs two energy-sensitive materials 14, 16. The system 10 further includes an activation system 18 for activating a first energy-sensitive material 14 and a read system for reading a spiral track 22 of the disc 12 for selectively activating the second energy-sensitive material 16. For illustrative purposes, the second energy-sensitive material 16 is shown disposed concentrically about an outer portion of the disc 12. In the present specific embodiment, both energy-sensitive materials 14, 16 are disposed near a read surface of the disc 12 as discussed more fully below. A read surface of an optical disc, such as the optical disc 12, may be the surface of the disc through which a laser of a read system passes to observe data stored via the optical disc.

The read system 20 further includes a read laser system 22 in communication with a disc-drive controller 24. The disc-drive controller 24 communicates with authoring software 26 and disc-locking software 28, which are automatically loaded into memory 30 of the read system 20 when the first energy-sensitive material 14 has been activated by the activation system 18 and after the disc 12 is inserted into the read system 20. The read system 20 may be implemented via a conventional disc player, copier, and/or writer without departing from the scope of the present invention.

The drive controller 24 may include a control algorithm and an accompanying actuator for controlling the read-laser system 22. The read-laser system 18 may include one or more optical pickups, a Digital-to-Analog Converter (DAC), amplifiers, and so on. A disc reader, such as the read system 20, may be any device adapted to access information from a disc. Hence, disc copiers and disc players are also considered disc readers for the purposes of the present discussion.

The optical disc 12, which is not shown to scale, includes a spiral track 14, which is strategically pitted to encode information that may be readable by the read system 20 when the energy-sensitive materials 14, 16 are appropriately activated. The read-laser system 18 produces a read laser beam 32, which reflects off of patterned pits and lands 34 included in the track 24. The pattern of reflected light may be employed by the read system 20 or an accompanying computer to decode information encoded via the pits and lands 34. For illustrative purposes, the optical disc 12 is shown further including an optional burst-cutting area 36, which may include a portion of the track 22 that includes content-protection code. Code may be any hardware or software instructions.

For the purposes of the present discussion, pits may represent depressions in a layer of an optical disc, such as the disc 12, that result in absorption and/or destructive interference of light from a read laser beam, such as the laser beam 32. Lands may represent portions of the same layer that reflect the light from the read laser beam. The layer that implements that pits and lands of an optical disc may be made from a metal, such as aluminum.

An energy-sensitive material, such as energy-sensitive ink, dye, or pigment, may be any material that changes nature, such as color or transparency, in response to application of energy, such as optical energy, vibrational energy, or acoustic energy. Optical energy may be any energy within a portion of the electromagnetic spectrum between and including ultraviolet and radio frequencies.

Transmissivity of a material to a certain energy beam may be the property of the material that determines how much energy from the energy beam transmits through the material. For example, a transparent material will have a high transmissivity, while an opaque or reflective material can have no or altered transmissivity.

An optical device may be any device or medium that employs optical energy to function as desired. An optical disc may be any optical device that is employed to store, provide, and/or manipulate data, such as in response to selective application of electromagnetic energy, such as optical energy. An optical disc may employ a beam of electromagnetic energy, such as optical energy, for reading and/or writing data to/from the optical disc. Examples of optical discs include, but are not limited to, Digital Video Discs (DVDs), Compact Discs (CDs), CD Recordable (CDR) media, CD Read/Write (CDRW) media, Blu-Ray discs, High-Density (HD) discs, optical memory cards, credit cards, Subscriber Identity Module (SIM) cards, and so on. A beam-producing device may be any device that can produce a beam of energy, such as a beam of ultrasound, infrared, or laser energy.

Data stored on an optical medium can be by any suitable physical effect, and can be organized in any data format. For example, traditional DVDs use physical structures of pits and lands to generate readable effects that are translated into data. The data is organized according to standards promulgated by the DVD Format/Logo Licensing Corporation. It should be apparent that any suitable manner of representing information in the medium, and any desired format of the information may be employed. The medium can be any shape (it need not be a disc, for example) and various ways of reading data from the medium are possible. For example, multiple beams, holographic approaches, etc. can be used. Various types of energy may be used reading or to produce a change in a material. For example, electromagnetic, acoustic, vibrational, etc. types of energy may be employed.

A theft-prevention system may be any apparatus, software, hardware, energy beam, instructions, or combination thereof capable of inhibiting theft or otherwise intended to reduce, inhibit, or prevent theft of any property.

In operation, the activation system 18 produces an activating energy beam 38. Characteristics of the activating energy beam 38 are selected in accordance with the type of the first energy-sensitive material 14. In the initial non-transparent state, the first energy-sensitive material 14 is sufficiently thick to block or interfere with the read laser beam 32 to prevent the read system 20 from reading the optical disc 12. When the first energy-sensitive material 14 is in a transparent state, the read laser beam 32 can sufficiently penetrate the first energy-sensitive material 14 to enable the read system 20 to read the track 22. The read system 20 may be implemented via a CD-ROM drive, DVD player, and so on. In practice, the activation system 18 employs the activating energy beam 38 to selectively change the transparency of the first energy-sensitive material 14 to activate the optical disc 12 as needed.

A user may control activation system 18. Alternatively, activation system 18 is automatically controlled. For example, a user may activate the optical disc 12 via the activation system 18 upon purchase. Alternatively, activation system 18 may be automatically controlled by another device, such as a cash register, in response to payment for optical disc 12 at a merchant outlet.

Characteristics of the activating energy beam 38 are selected in accordance with the type of material used to implement the energy-sensitive material 14. For example, the first energy-sensitive material 14 may be activated, i.e., bleached or made transparent in response to a certain wavelength or intensity of light. The activation system 18 produces the activating energy beam 38 with the desired wavelength and/or intensity characteristics sufficient to activate the first energy-sensitive material 14.

The first energy-sensitive material 14 may be readily implemented via various types of dyes, inks, or pigments, such azo ink, or the Dye System 351 family of products from Veriloc LLC, a partnership between Uniloc USA and Verification Technologies, Inc., without departing from the scope of the present invention. Other suitable materials include readily available CD-R and DVD-R recording dyes, including cyanine and phthalocyanine azo dyes, which are reactive to ultrasonic degradation in additional to optical degradation at specific wavelengths and intensities.

The first energy-sensitive material 14 and the second energy-sensitive material 16 may be deposited on the optical disc 12 via one or more well known techniques, such as spin coating, sputter coating, masking, and so on. Those skilled in the art with access to the present teachings may readily determine a suitable technique, without undue experimentation, to meet the needs of a given application.

The first energy-sensitive material 14, which is positioned near a read surface of the optical disc 12, acts as an anti-theft mechanism by preventing playing, copying, or otherwise reading of content from the optical disc 12 before the optical disc 12 is activated via the activation system 18. After the activation system 18 activates the first energy-sensitive material 14, the second energy-sensitive material 16 may be exposed to the read laser beam 32 of the read system 20. For the purposes of the present discussion, a disc reader, such as the read system 20, may be any device that can access information from a disc, such as the optical disc 12. Hence, disc copiers and disc players are also disc readers.

In the present specific embodiment, the second photosensitive material 16 acts as an anti-copy material, i.e., a material that prevents copying of the optical disc 12, as discussed more fully below. Alternatively, the second photosensitive material 16 may also act as an anti-play or anti-read material for preventing playing or reading of certain content from the disc 12 when the disc 12 is not authentic.

The second energy-sensitive material 16 is a photosensitive material. For the purposes of the present discussion, a photosensitive material may be any material exhibiting a property, such as transparency, reflectivity, or opacity, that changes in response to application of predetermined optical energy. For example, in the present specific embodiment, optical energy represented by the activation beam 38 changes the first photosensitive material from non-transparent or opaque to transparent. A material is said to be opaque or non-transparent to certain energy, such as optical energy of a certain wavelength impinging on the material, if the energy is absorbed or otherwise prevented from passing through the material or reflecting from the material. A material is said to be transparent to optical energy if the optical energy can pass through the material without being substantially reflected, absorbed.

The second energy-sensitive material 16 is an optically transient material. For the purposes of the present discussion, an optically transient material includes any material that exhibits an optical property, such as transparency, reflectivity, refractivity, opacity, absorption, etc., that can be triggered (e.g., by energy) to temporarily change. Similarly, a transient optical property may be any optical property that changes temporarily.

In an exemplary operating scenario, after the first material 14 is activated by the activation system 18, such as upon purchase of the optical disc 12, a user inserts the optical disc 12 in to the read system 20. Authoring software and disc-locking software that is stored on the burst-cutting area 36 is automatically loaded to the memory 30 of the read system 20. Alternatively the read system 20 is instructed to run the authoring software 26 and disc-locking software 28 from the optical disc 12.

For the purposes of the present discussion, authoring software or authoring code may be any code that is executed by a computer or other processor, such as a processor in the disc-drive controller 24, when a data-storage medium is inserted into a device, or may be in proximity to the read system such as the read system 20, designed to read the data-storage medium. Disc-locking software or code may be any code that may prevent a reader from reading a data-storage medium.

The authoring software 26 is then executed by the read system 20, such as via a processor included in the disc-drive controller 24. The authoring software 26 includes instructions that cause the read system 20 to attempt to read data from the portion of the disc 12 corresponding to the second energy-sensitive material 16/or adjacent to same. The authoring software 26 may cause the read system 20 to attempt to read a portion of the track 22 under the second energy-sensitive material 16 multiple times. After a certain number of read attempts, the read laser 32 bleaches the second energy-sensitive material 16, which may thereby expose different data in tracks under the second energy-sensitive material 16. The authoring software 26 then observes the change in results obtained by the read system 20 for the different read attempts. If the change in results matches what would be expected from an authentic disc, then the authoring software 26 considers the disc 12 authenticated. Information pertaining to what is expected of an authentic disc may be stored in the authoring software 26. Alternatively, this information may be stored in patterns formed via the second material 16.

If the authoring software 26 does not observe an appropriate change in results from attempts to read disc region corresponding to the second energy-sensitive material 16, then the optical disc is not considered authentic. The authoring software 26 may then cause a predetermined motion of the disc 12 or read laser beam 32 or may cause another action that is detected by the disc-locking software 28. The disc-locking software 28 then locks the disc 12, thereby preventing unauthorized playing or copying of content from the unauthorized disc 12.

The authoring software 26 may include instructions for the read system 20 to jump between files. The instructions may provide for a specific head movement or drive speed change due to the presence of the instructions and the second energy-sensitive material 16. Disc-locking software 28 may include code to anticipate the movements and lock the read system 20 if the appropriate movements at predetermined locations are not detected.

When a user attempts to copy an authentic disc, a higher disc rotational rate, which may occur during copy operations, may cause the second energy-sensitive material 16 to change in a predetermined way. This change may expose additional authoring code that triggers the disc-locking software 28, thereby preventing copying of the disc 12 at high speeds. Even if a disc is copied at low speeds, the resulting copy of the disc will not be playable without the presence of the second energy-sensitive material 16 in a specific location on the optical disc 12.

Requisite authoring software 26 and disc-locking software 28 may be developed by those skilled in the art with access to the present teachings without undue experimentation. For example, one may employ pre-existing disc-locking software without departing from the scope of the present invention.

Hence, the system 12 can inhibit playing of content from the disc 12 when the disc 12 is not first activated; can prevent copying of content from the optical disc 12 at high speeds; and can prevent playing or copying of a non-authentic optical disc. Such capabilities are enabled by strategic use of the first material 14 and the second material 16 in combination with the authoring software 26 and disc-locking software 28.

One or more of these components of the system 10 may be omitted without departing from the scope of the present invention. For example, in an alternative embodiment, the authoring software 26 and the disc-locking software 28 are omitted. Furthermore, the first energy-sensitive material 14 is replaced with the second energy-sensitive material 16, which then covers the read surface of the optical disc 12. In this embodiment, the second energy-sensitive material 16 is optically transient, and changes from transparent to opaque when a sufficient number of photons impinge on a given region of the material within a given time period. The rate at which the second energy-sensitive material 16 becomes opaque is selected so that reading of the disc 12 at slow speeds, such as 1× speeds, does not cause the second energy-sensitive material 16 to be come opaque. However, reading the optical disc 12 at high speeds will cause sufficient photons from the read laser beam 32 to impinge on the second energy-sensitive material 16, thereby causing it to darken, thereby preventing copying of the optical disc 12 at high speeds but enabling playing of the disc at low speeds. Additional mechanisms may be employed to prevent copying of the optical disc 12 at slow speeds.

This alternative embodiment is readily adapted to various applications, such as temporary-play applications. For example, the second energy-sensitive material 16 can be adjusted so that an optical disc may be played only a predetermined number of times during a given time interval before the second energy-sensitive material 16 temporarily changes to inhibit further playing of the optical disc.

Hence, the energy-sensitive material 16, itself, may be adapted to allow a predetermined number of consecutive plays. Alternatively, changes in the energy-sensitive material 16, such as due to consecutive repeat plays, may cause activation of disc software that disables further plays of the accompanying optical disc.

The first energy-sensitive material 14 may be replaced with another type of material that is not sensitive to optical energy without departing from the scope of the present invention. For example, the first energy-sensitive material 14 may be another type of energy-sensitive material, such as a material that is sensitive to ultrasound or another type of energy. An energy-sensitive material may be any material having a property that changes in response to the application of predetermined energy.

While the present embodiment employs photosensitive materials 14, 16, other types of energy-sensitive materials may be employed in various embodiments instead of or in addition to photosensitive materials, without departing from the scope of the present invention. For example, certain inks or dyes may respond to energy other than optical energy, such as vibrational energy, and/or ultrasound.

Furthermore, while the photosensitive materials 14, 16 are discussed as being either non-transparent or transparent, other variations are possible, such as semi-non-transparent and sufficiently transparent to enable read system 20 to read optical disc 12. Alternatively, one or more of the photosensitive materials 14, 16 may be partially reflective or may exhibit a specific material that renders read-laser system 20 ineffective at reading track 22 when the material is not activated.

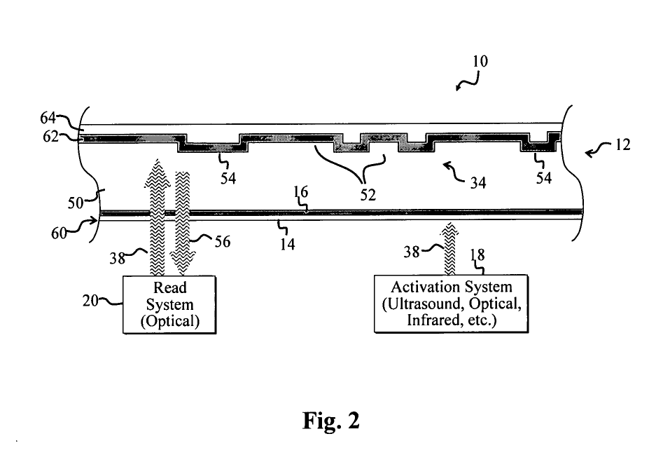

FIG. 2 shows a cross-section of the optical disc 12 of the system 10 FIG. 1. In this embodiment, the first energy-sensitive material 14 overlaps the second energy-sensitive material 16. Both materials 14, 16 are coated on the surface of a transparent polycarbonate layer 50 through which the read laser beam passes 38.

The optical disc 12 is shown including a read surface 60, a transparent polycarbonate layer 50, a metal layer 62 that has pits and lands 34 and that is positioned on the transparent layer 50, and a backing layer 64, which may be made from various materials, such as acrylic or other disc lacquers. One or more protective layers, such as lacquers, in addition to the layers formed by the energy-sensitive materials 14, 16, may be added to the read surface 60.

In operation, the activation system 18 applies the activating energy beam 38 to the optical disc 12, thereby activating the first energy-sensitive material 14 by causing the material 14 to transition from non-transparent to transparent. Subsequently, the read system 20 employs the read laser 20 to attempt to read the pits and lands 34, which are shown including separate pits 52 and land 54.

If the read laser beam 38 impinges on the second energy-sensitive material 16 for a certain duration or impinges on the material 16 a certain number of times in a given interval, the second energy-sensitive material 16 becomes transparent so that the read system 20 can read the pits and lands 34 via a reflected beam 56.

The second energy-sensitive material 16 may be considered to exhibit a first optical characteristic, such as opacity, when the optical disc 12 is read by a disc drive, such as the read system 20, at a first rate. The second energy-sensitive material 16 exhibits a second optical characteristic, such as transparency, when the optical disc 12 is read by the read system 20, i.e., disc drive at a second rate.

The authoring software 26 and disc-locking software 28 may be considered as including one or more instructions to inhibit reading of data from the optical disc 12 based on the first optical characteristic or the second optical characteristic.

The energy-sensitive materials 14, 16 are employed to selectively affect how the optical disc 12 is read or copied. For example, to authenticate the disc, the read system 20 may attempt to read the pits and lands 34, expecting to not detect the pits and lands on the first attempt. The read system 20 may attempt to read the pits and lands 34 multiple times until the second energy-sensitive material 16 becomes transparent, exposing the pits and lands 34. Subsequently, the authoring software loaded to the read system 20 confirms that the disc 12 is authentic based on the behavior of the disc 12 or both the behavior of the disc 12 and the resulting underlying data encoded in the pits and lands 34.

The second energy-sensitive material 16 then returns to its original state after the optical disc 12 has been authenticated. This enables the optical disc 12 to be reauthenticated.

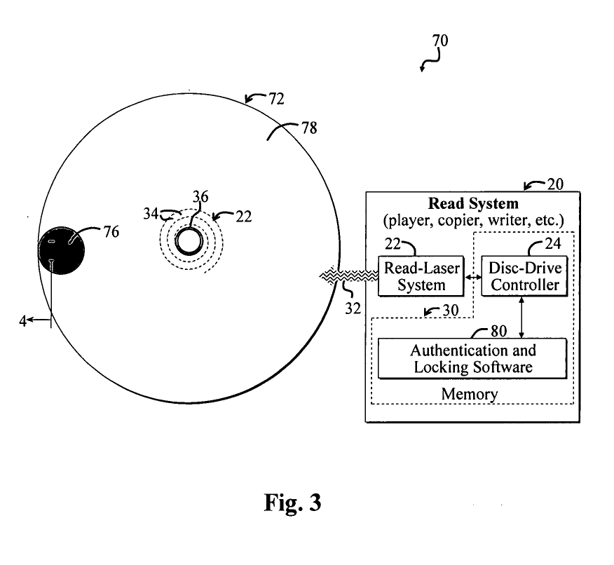

FIG. 3 shows an alternative embodiment 70 of the system 10 of FIG. 1, that employs energy-sensitive material 76 at a predetermined location on a disc 72 according to a second embodiment of the present invention. Unlike the optical disc 12 of FIG. 1, the disc 72 of FIG. 3 lacks the first energy-sensitive material 14, and instead, includes the alternative energy-sensitive material 76. Furthermore, the energy-sensitive material 76 is positioned in a different location on the disc 72.

In addition, instead of being incorporated near a read surface of the disc 72, the energy-sensitive material 76 is disposed on or near a pits and lands behind a transparent portion 78 of the disc 72, as discussed more fully below. The authoring software 26 of FIG. 1 is replaced with authentication and locking software 80 in FIG. 3. The authentication and locking software 80 is automatically loaded from the disc 72 and run by the read system 20 when the disc 72 is inserted into the read system 20.

The functionality of the authentication and locking software 80 is similar to the authoring software 26 and disc-locking software 28 of FIG. 1 with a few exceptions. The authentication and locking software 80 is adapted to read the different location corresponding to location of the energy-sensitive material 76. Furthermore, the software 80 is adapted to read patterns in the energy-sensitive material 76 itself; patterns resulting from the combination of the track 22 and accompanying patterned energy-sensitive material 76; and underlying data in the track 22 when the energy-sensitive material 76 becomes transparent. The various patterns may represent different types of information. Hence, one region of the disc 72 may contain different types of information, some of which is stored or maintained in patterns in the energy-sensitive material and/or in the properties exhibited by the energy-sensitive material 76. For example, the energy-sensitive material 76 may include various sub-regions with differing transient optical properties. The differences in these properties may be patterned to yield desired information.

In one operative scenario, the energy-sensitive material 76 is configured to produce an error when initially read by the read system 20 and to provide valid data after a predetermined number of reads of the region corresponding to the energy-sensitive material. The transition from an error state to a valid state may be used by the authentication and locking software 80 to authenticate the disc 72. Alternatively, data read from the region corresponding to the energy-sensitive material 76 may be initially valid and then transition to invalid, or the data may be initially valid and transition to another set of valid data. These transitions may be adjusted to meet the needs of a given application.

For the purposes of the present discussion, the term authenticate may mean to verify information. For example, when authenticating a disc, such as the disc 72, the system 70 verifies information, such as information affected by the presence of predetermined energy-sensitive material 76 disposed on the disc 72. This information indicates to the authentication and locking software 80 whether the disc 72 is an authorized disc or not. If the disc 72 is authorized, i.e., authentic, the authentication and locking software 80 allows the read system 20 to play the disc 72 but not to copy the disc 72. Alternatively, the authentication and locking software 80 selectively enables or disables different features and functionality other than playing or copying depending on the behavior of the energy-sensitive material 76 and the data associated with the region corresponding to the energy-sensitive material 76.

Authoring code, such as the authentication and locking software 80, may include instructions for causing the read laser 32 of the read system 20 to read from a predetermined region 76 of the optical disc 72 on or in which the material 76 is intended to be disposed and providing a first signal when the material is disposed on or in the optical disc 72 at the predetermined region and providing a second signal when the material 76 is not disposed on or in the optical disc 76 at the predetermined region.

The controller 24 of the read system 20 is adapted to cause the read system 20 to exhibit a first behavior, such as enabling playing of the optical disc 72, in response to the first signal, and a second behavior, such as preventing playing of the optical disc 72, in response to the second signal.

The first behavior may include the read laser 32 skipping between files stored on the optical disc 72 or spinning the optical disc 72 at a predetermined rate. Disc-locking code included in the authentication and locking software 80 may include instructions to lock the optical disc 72 in response to detection of the second behavior. An optical disc is said to be locked when an accompanying read system is prevented from reading the optical disc.

The optically transient energy-sensitive material may include information encoded therein. In one embodiment, the information is adapted to enable the disc read system 20, which may act as a disc player and/or copier, to play content from the optical disc and to prevent copying of content from the optical disc 72.

The system 70 may be considered a system for selectively enabling reading, playing, or copying of an optical disc, 72. In this case, the system 70 includes a first mechanism 20, 30 for observing a predetermined region 76 on or in the optical disc 72 to verify the presence of a certain material 76 and providing a signal in response thereto. A second mechanism selectively prevents reading, playing, or copying of the optical disc in response to the signal.

The authentication and locking software 80 may further include one or more instructions for limiting use of one or more portions of data stored in or on the optical disc 72 when the optical disc is not authentic determined by the authentication and locking software 80. The instructions for limiting use may include instructions for preventing copying or playing of the one or more portions of data.

The energy-sensitive material 76 may be implemented via one of the Dye System 349 family of products, which is available from Veriloc LLC, a partnership between Uniloc USA and Verification Technologies, Inc. A suitable Dye System 349 dye may be made by, for example:

1. Mixing the following ingredients and leaving overnight: 36.4 of hydroxy-ethylmethacrylate (HEMA) or polymethylmethacrylate (PMMA), 230 mls of methoxy propanol, 7.5 grams of Bis Tris, and 3.75 grams of methylene blue dye;

2. Pre-filtering the resulting mixture via 1.5 mm vacuum filtration; and

3. Filtering the resulting mixture with a sandwich system 1.5 mm filter on top of a Durapore 0.22 μm filter.

It should be apparent that the above steps can be modified, that steps may be added to or subtracted from these steps, and a suitable material can still be produced.

While the disc 72 of FIG. 3 is shown lacking a first energy-sensitive material and accompanying activation system, one may be included with the embodiment of FIG. 3 without departing from the scope of the present invention.

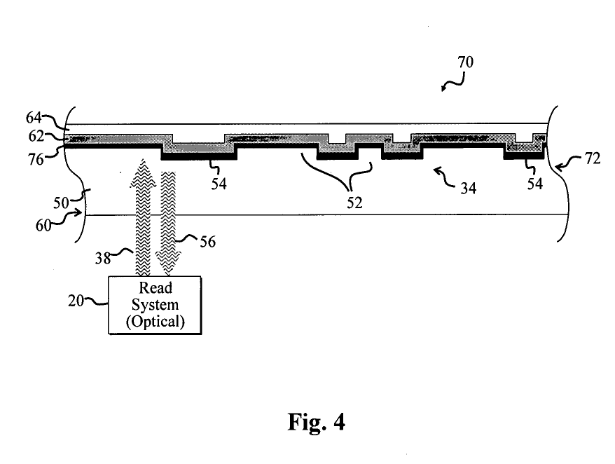

FIG. 4 shows a cross-section of the optical disc 70 of FIG. 3, wherein a an energy-sensitive material with transient optical properties is selectively disposed over pits of the disc 70, thereby affecting the way the disc pits and lands 34 are read by an accompanying read system.

The optically transient energy-sensitive material 76 is deposited, such as via sputter coating, on the transparent polycarbonate layer 50, which has been patterned to exhibit the pits and lands 34. Subsequently, the metallic layer 72 is deposited, coated, or otherwise diffused over the energy-sensitive material 76. Next, a protective lacquer 64, such as acrylic lacquer, is applied on top the metallic layer 62.

In operation, the read laser beam 38 from the read system causes temporary changes in transparency or another optical property of the optically transient energy-sensitive material 76. These temporary changes are exploited by software automatically loaded to the read system 20 from the disc 72 to authenticate the disc 72 and to selectively enable or disable certain functionality, such as playability.

While embodiments discussed herein are primarily used to selectively enable playing of disc content and to disable copying of disc content, other embodiments are possible. For example, principles disclosed herein may be employed to control other functions, such as functions of software stored on the disc 72, without departing from the scope of the present invention.

The optically transient energy-sensitive material 76 is initially non-transparent in the present embodiment, and then becomes temporarily transparent in response to predetermined exposure to the read laser 38. However, the optically transient energy-sensitive material 76 may be initially transparent and then become temporarily opaque with certain exposure to the read laser beam 38, without departing from the scope of the present invention.

Furthermore, embodiments of FIGS. 1-2 and FIGS. 3-4 may be combined in various ways without departing from the scope of the present invention. For example, the optically transient material 76 may be positioned at the input surface 60 of the disc 72, and the first energy-sensitive material 14 of FIG. 1 may be positioned adjacent to the metallic layer 62 in certain applications.

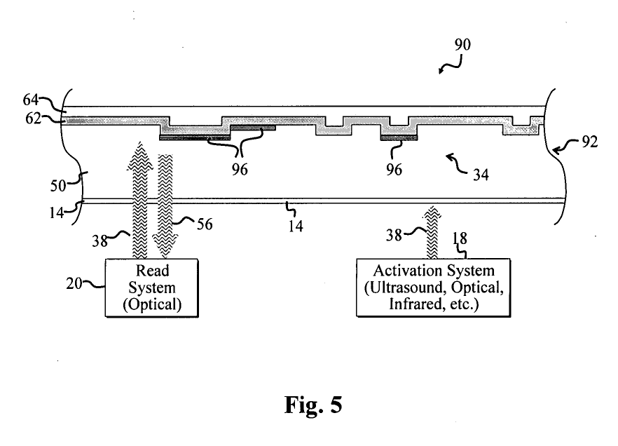

FIG. 5 shows a cross-section of a third optical disc 92 with an accompanying optically transient energy-sensitive material 96 disposed in a predetermined pattern over pits and lands 34 of the third optical disc 92 according to a third embodiment of the present invention.

The third disc 92 includes the first energy-sensitive material 14, which is spin coated on the side of the transparent polycarbonate material 50 that is opposite the metallic layer 62. The activation system 18 employs the accompanying energy beam 38 to activate the first energy-sensitive material 14, transitioning the material 14 from an initially non-transparent state to a transparent state.

After activation of the disc 92, the read system 20 may employ the read laser beam 38 to attempt to read the pits and lands 34. However, the presence of the strategically positioned optically transient energy-sensitive material 96 causes the read system 20 to initially read a first set of data and then subsequently read a second set of data after the optically transient energy-sensitive material 96 is bleached, i.e., made transparent by the read laser 38. When reading the first set of data, the opacity of the energy-sensitive material 96 may make lands appear as pits to the read system 20. Alternatively, the optically transient energy-sensitive material 96 is a copper-colored reflective material that initially makes pits appear as lands.

Differences in data read by the read system 20 from the same region of the disc 92 at different times is exploited by software loaded to the read system 20 to facilitate disc authentication, playability, and so on.

The selectively deposited optically transient material 96 may be applied during manufacturing of the disc 92. A conventional masking process using photo resist or other techniques may be employed to deposit the optically transient material 96.

The pattern exhibited by the optically transient energy-sensitive material 96 may effect a change in the way underlying data formed via the pit and land structures 34 is read. The underlying data may represent software. In this case, strategic use of the optically transient energy-sensitive material 96 results in a transient change in software read from the disc 92 when a predetermined amount and/or type of energy is applied to the material 96. In this embodiment, the predetermined amount and/or type of energy, which causes the temporary change in software, is provided by the read laser beam 38. Hence, the material 96 has properties that may be employed to change a read property of a pit or land over time.

The additional information, which may be stored in the patterns resulting from the selective placement of the energy-sensitive material 96, is generally not copyable to a second disc by a disc copier adapted to copy data solely by reading and copying pits and lands of an optical disc.

Note that in various embodiments of the present invention, the various energy-sensitive materials, such as the materials 14 and 96, may be applied sequentially in spin coats before final lacquer protective coating is applied. The materials may applied together in a spin coat; sputter coated an applied before the metal layer 62; sputter coated an applied before an exterior lacquer coating; sputter coated and applied during metalization; sputter coated with photo masking to strategically position the materials; placed via photo mask at the lead-in and/or the disc burst-cutting areas, and so on. Those skilled in the art will know where and how to apply the materials to meet the needs of a given application.

Those skilled in the art with access to the present teachings may readily manufacture or order manufactured various embodiments disclosed herein without undue experimentation.

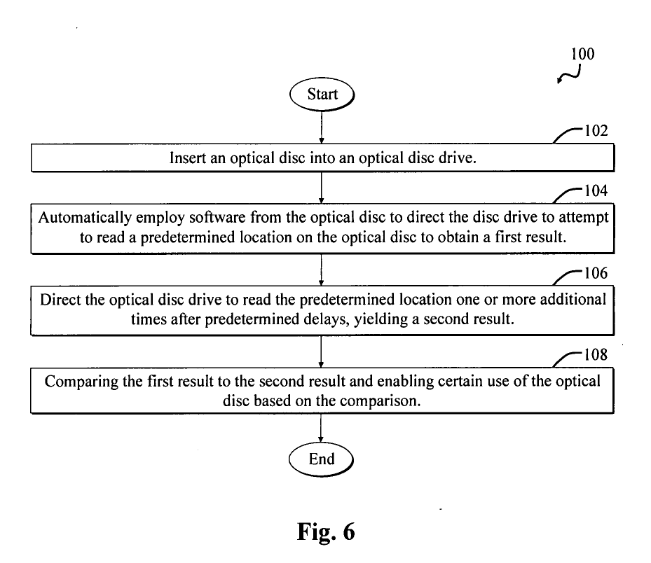

FIG. 6 shows a flow diagram of a first method 100 adapted for use with the embodiments of FIGS. 1-4. The method 100 includes a first step 102 wherein an optical disc is inserted into an optical disc drive.

In a second step 104, code included in the optical disc is automatically directs the disc drive to read a predetermined location on the optical disc, thereby obtaining a first result. The location may be, for example, the location corresponding to the optically transient energy-sensitive material 76 of FIG. 3.

In a third step 106, the code directs the optical disc drive to read the predetermined location one or more additional times after which the region produces a second result when read.

A fourth step 108 includes comparing the first result to the second result and providing a signal in response thereto. The code employs the signal to selectively enable or disable certain usage or functionality of the disc. For the purposes of the present discussion, the term functionality of a disc may be any capability or feature associated with the disc. Examples of functionality include playing and copying capabilities and features and capabilities offered by software functions included in a disc.

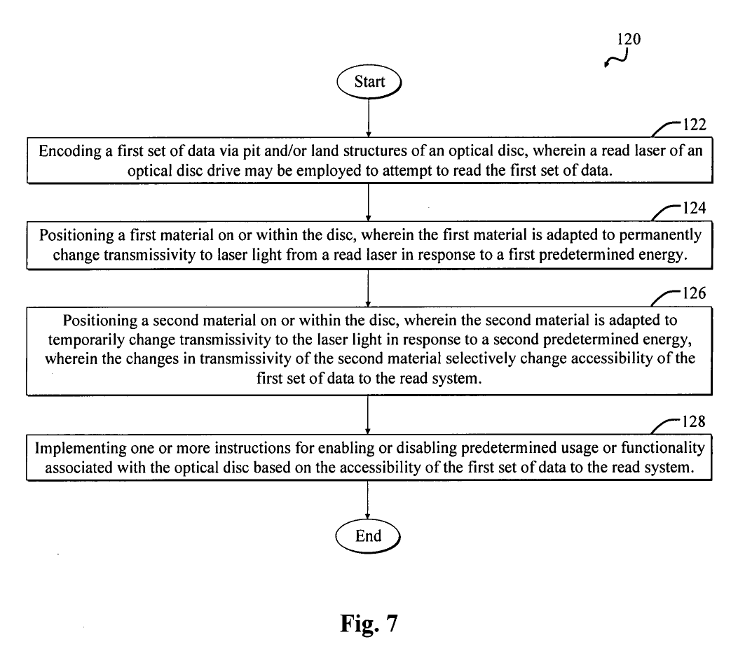

FIG. 7 shows a flow diagram of a second method 120 adapted for use with the embodiments of FIGS. 1-4. The second method 120 includes a first step 122, wherein a first set of data is encoded via pit structures of an optical disc. A read laser of a read system may be employed to attempt to read the first set of data.

In a second step 124, a first material is positioned on or within the disc. The first material permanently changes transparency in response to a first predetermined energy, such as ultrasound or laser light of a predetermined frequency and duration.

In a third step 126, a second material is positioned on or within the disc. The second material temporarily changes transparency in response to a second predetermined energy, such as light from the read laser for a particular duration and/or frequency. Changes in transparency of the second material affect accessibility of the first set of data to the read system.

A fourth step 128 includes executing code for enabling or disabling predetermined functionality associated with the optical disc based on the accessibility of the first set of data to the read system.

Various steps of the methods 100, 120 of FIGS. 6 and 7 may be interchanged or omitted without departing from the scope of the present invention. For example, the second step 124 of the method 120 of FIG. 7 may be omitted in certain implementations.

While the embodiments herein have been discussed primarily with respect to systems for affecting functionality, such as playability, of an optical disc, the invention is not limited thereto. For example, embodiments of the present invention may be adapted to other types of storage media without departing from the scope of the present invention. Generally, additional material may be added to virtually any electronic or optical data-storage medium to selectively affect functionality of the storage medium in accordance with an embodiment of the present invention. For the purposes of the present discussion, a data-storage medium may be any medium, material, or device that can store information.

Depending upon the materials selected for embodiments of the present invention, light activation may be permanent and non-reversible. In certain applications, non-reversible inks are preferred, whereas in other applications, such as rental applications, reversible inks may be preferred. The transparency of certain inks or materials may be reversed via application of predetermined energy.

Exact methods for activating suitable dyes, pigments, or other materials, such as by making the materials transparent or non-transparent to particular frequencies of electromagnetic energy, are generally application-specific. Activation may be implemented via an external source, such as an external light source, a vibration system, ultrasound system, etc. Generally, desired material-activation times are also application specific. However, in embodiments disclosed herein, activation times are generally less than one minute.

Various embodiments of the present invention may provide important capabilities and features for merchants of various optical products, such as CDs and DVDs. Such capabilities and features may include simple and reliable one-time activation at the point of sale; exposure to twenty four hours of direct sunlight will not activate the optical device; activation time of less than one minute; simultaneous activation of plural optical devices, such as stacked or layered discs; activation through product packaging, including product cases; may be cost effectively implemented; may be difficult to reverse engineer, and may not degrade the long term performance of the accompanying optical device.

Those skilled in the art may construct suitable materials and associated activation equipment to selectively alter the chemistry of the materials to affect transparency without undue experimentation. Conventional systems for inducing changes in material chemistry may be adapted for use with embodiments of the present invention without departing from the scope thereof.

While certain embodiments disclosed herein are discussed primarily with respect to one-time activation, temporary activation, and authentication of an optical disc, to prevent or thwart theft or other unauthorized use of the optical disc or other device, the invention is not limited thereto. For example, different materials or combinations thereof may be employed to enable multiple state changes for a given energy-sensitive layer, thereby allowing multiple activations and deactivations of an optical device or other data-storage medium. Multiple activations and deactivations may be particularly important in rental applications or sampling applications, such as movie rentals or music sampling, where optical devices may need repeated activation and deactivation.

Although certain embodiments of the invention are discussed with respect to systems and methods for inhibiting theft of an optical device or unauthorized copying of associated content, other uses and features are possible. Various embodiments discussed herein are merely illustrative, and not restrictive, of the invention. For example, energy-sensitive materials in accordance with the present teachings may be employed to thwart copyright infringement of content stored on a magnetic disc or other type of data-storage medium.

Although a process of the present invention may be presented as a single entity, such as software executing on a single machine, such as the read system 20, such software can readily be executed on multiple machines. That is, there may be multiple instances of a given software program, a single program may be executing on two or more processors in a distributed processing environment, parts of a single program may be executing on different physical machines, etc.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, Field of the Invention, Title, or Summary, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A system for inhibiting unauthorized use of an optical disc, the system comprising:
first data encoded via pit structures of the optical disc;
a read system adapted to read the first data by using at least one laser light;
a first material positioned on or within the disc, wherein the first material is adapted to change transmissivity to a laser light in response to a first predetermined energy;
a second material positioned on or within the disc, wherein the second material is adapted to temporarily change transmissivity to a laser light, in response to a second predetermined energy, wherein changes in transmissivity of the first material and the second material selectively change accessibility of the first data to the read system; and
instructions for enabling or disabling predetermined functionality associated with the optical disc based on the accessibility of the first data to the read system.

2. The system of claim 1 further including:
first means for applying the first predetermined energy to the first material before the laser light changes transmissivity of the second material.

3. The system of claim 2, wherein the first material is adapted to permanently change transparency in response to the first predetermined energy.

4. The system of claim 1, wherein the first predetermined energy includes:
ultrasound.

5. The system of claim 1, wherein the second predetermined energy includes:
light energy from a read laser of a disc reader.

6. The system of claim 1, wherein the predetermined functionality includes:
playing of content from the optical disc.

7. The system of claim 1, wherein the predetermined functionality includes:
copying of content from the optical disc.

8. A system for selectively inhibiting or enabling use of a data-storage medium, the system comprising:
a material adjacent to the data-storage medium, the material characterized by a property that temporarily changes from a first state to a second state in response to application of certain energy;
data stored via the data-storage medium; and
first means for selectively affecting reading of the data based on the property of the material.

9. The system of claim 8, wherein the material is positioned on the data storage medium.

10. The system of claim 8, wherein the material is in proximity to the data storage medium.

11. The system of claim 8, wherein the material is within the data storage medium.

12. The system of claim 8, wherein the data-storage medium includes:
an optical disc.

13. The system of claim 12, wherein the material exhibits a first optical characteristic when the optical disc is read by a disc drive at a first rate, and wherein the material exhibits a second optical characteristic when the optical disc is read by the disc drive at a second rate.

14. The system of claim 13, wherein the first means includes:
one or more instructions to inhibit reading of data from the optical disc based on the first optical characteristic or the second optical characteristic.

12. The system of claim 14, wherein the first optical characteristic is opacity, and the second optical characteristic is transparency.

16. The system of claim 12, wherein the first means includes:
authoring code.

17. The system of claim 16, wherein the authoring code includes:
instructions for causing a read laser of a read system to read from a predetermined region of the optical disc on or in which the material is intended to be disposed and providing a first signal when the material is disposed on or in the optical disc at the predetermined region and providing a second signal when the material is not disposed on or in the optical disc at the predetermined region.

18. The system of claim 17, wherein a controller of the read system is adapted to cause the read system to exhibit a first behavior in response to the first signal and a second behavior in response to the second signal.

19. The system of claim 18, wherein the first behavior includes:
the read laser skipping between files stored on the optical disc.

20. The system of claim 18, wherein the first behavior includes:
spinning the optical disc at a predetermined rate.

21. The system of claim 18 further including:
disc-locking code adapted to lock the optical disc in response to the second behavior.

22. A system for selectively enabling playing or copying of content from a data-storage medium, the system comprising:
a first material disposed on or in the data-storage medium;
a second optically transient material disposed on or in the data-storage medium; and
first means for employing the first material and the second material to selectively inhibit playing or copying of the content.

23. A system for selectively enabling reading, playing, or copying of an optical disc, the system comprising:
first means for observing a predetermined region on or in the optical disc to verify the presence of a certain material and providing a signal in response thereto; and
second means for selectively preventing reading, playing or copying of the optical disc in response to the signal.

24. The system of claim 23, wherein the certain material includes:
a material that exhibits transient optical properties that change after application of predetermined energy.

25. The system of claim 24, wherein the predetermined energy includes:
laser light applied to the material.

26. The system of claim 25, wherein changes in the transient optical properties affect readability or playability of data stored via the optical disc.

27. A method for selectively enabling certain use of an optical disc comprising, the method comprising:
automatically employing certain code from an optical disc to direct an accompanying optical disc drive to read a predetermined location on the optical disc and obtain a first result;
directing the optical disc drive to read the predetermined location one or more additional times after a predetermined delay, resulting in a second result;
comparing the first result to the second result and providing a signal in response thereto; and
enabling the certain use of the optical disc based on the signal.

28. The method of claim 27, wherein the certain use includes:
playing or copying of content stored in or on the optical disc.

29. A system for selectively inhibiting or enabling use of a data-storage medium, the system comprising:
a first material positioned in or on the data-storage medium, the first material adapted to temporarily change how a read system reads pits in an optical disc; and
a first mechanism responsive to the change and adapted to selectively affect playing and/or copying of data stored via the data-storage medium.

30. The system of claim 29, wherein the data-storage medium includes:
an optical disc.

31. The system of claim 30, wherein the first material includes:
optically transient material.

32. An optical disc that may be used for a predetermined time period comprising:
data stored via pits included in the optical disc; and
a material selectively disposed on or in the optical disc, the material having a property that temporarily changes from a first state to a second state in response to predetermined exposure from a read laser associated with the read system.

33. A optical disc comprising:
a first material disposed on or in the disc with patterned pit structures representing first data; and
a second material disposed on or in the disc, the material storing second data.

34. The optical disc of claim 33, wherein the second material includes:
a photosensitive material.

35. The optical disc of claim 33, wherein the second material includes a material responsive to vibrational energy to change a reading of the patterned pit structures.

36. The optical disc of claim 33, wherein the second material includes a material responsive to electromagnetic energy to change a reading of the patterned pit structures.

37. The optical disc of claim 34, wherein the second material includes:
an optically transient dye, pigment, or ink.

38. The optical disc of claim 34, wherein the second material is disposed on or in the optical disc in a predetermined pattern, the predetermined pattern representing some or all of the second data.

39. The optical disc of claim 34, wherein one or more properties of the material represent some or all of the second data.

40. The optical disc of claim 39, wherein the second data includes:
authentication information for determining if the optical disc is authentic.

41. A method for selectively inhibiting copying of content from an optical disc, the method comprising:
positioning optically transient material on a predetermined region of the disc; and
including activation software on the disc, the activation software adapted to observe a region of the disc associated with the optically transient material.

42. The method of claim 41, wherein the activation software is adapted to spin the disc at a predetermined rate and observe a predetermined region of the disc.

43. The method of claim 42, wherein the activation of software is adapted to observe the data at the predetermined region and to selectively disable copying of the disc based on the data.

44. The method of claim 43, wherein the data changes based on a transient optical property of the optically transient material.
